(19) United States
(12) Patent Application Publication
(10) Pub. No.: US 2025/0098678 A1
(43) Pub. Date: Mar. 27, 2025

(54) METHOD OF CONTROLLING FUNGI

(71) Applicants: UPL CORPORATION LIMITED, Port Louis (MU); UPL EUROPE LTD, Warrington (GB)

(72) Inventors: Luis Gustavo Rodrigues GONELLA, Sao Paulo (BR); Alicia MORENO, Sevilla (ES); Thais Tanan DE OLIVEIRA, Sao Paulo (BR); Hendrik Leonard YPEMA, Durham, NC (US); Jonatas Bredow ALVES, Durham, NC (US); Estelle MOREAU, Saint Malo (FR)

(21) Appl. No.: 18/832,577

(22) PCT Filed: Jan. 23, 2023
(86) PCT No.: PCT/GB2023/050141

§ 371 Date: Jul. 24, 2024

(30) Foreign Application Priority Data
Jan. 24, 2022 (EP) 22382049.9

(51) Int. Cl. A01N 43/50; A01N 25/04; A01P 3/00

(52) U.S. Cl. CPC A01N 43/50; A01N 25/04; A01P 3/00

(57) ABSTRACT

The present invention relates to a method for controlling fungal plant pathogens by applying cyazofamid to a plant propagation material. The present invention further relates to an effective method of seed treatment for controlling fungal plant pathogens and Oomycetes. More particularly, the present invention further relates to an effective method of seed treatment for controlling fungal species such as Plasmopara halstedii, Phytophthora sojae, or Pythium ultimum.

### FIELD OF INVENTION

The present invention relates to a method for controlling plant pathogens by applying cyazofamid to a plant or plant part or plant propagation material or to the locus thereof. The present invention relates to an effective method of seed treatment for controlling fungal plant pathogens.

### BACKGROUND OF THE INVENTION

Cyazofamid, 4-chloro-2-cyano-N,N-dimethyl-5-p-tolylimidazole-1-sulfonamide, a fungicide of the phenylimidazole chemical class, exhibits a broad spectrum of activity against Oomycetes and Plasmodiophoromycetes at very low rates. It has a good toxicological, ecotoxicological and environmental profile. The mode of action of cyazofamid is blocking electron transfer in the mitochondrial cytochrome bc₁ complex by binding the Qᵢ centre of the enzyme. Since this mode of action differs from commonly used fungicides, there are no issues of cross-resistance between cyazofamid and other fungicides, including strobilurin-type fungicides and phenylamides.

Crops are frequently infected by fungal plant pathogens, which can include seedborne fungi. In such scenarios, the pathogen is already present within or on the seed surface and can thus cause seed rot and seedling damping-off. Treatment of vegetable seeds has been shown to prevent plant disease epidemics caused by seedborne fungal pathogens.

Seed treatments can be useful in reducing the amounts of pesticides required to manage a disease, because effective seed treatments can eliminate the need for foliar application of fungicides later in the season. Although the application of fungicides is almost always effective, their non-target environmental impact and the development of pathogen resistance have led to the search for alternative methods, especially in the past few years. Physical treatments that have already been used in past and treatments with biopesticides, such as plant extracts, natural compounds and biocontrol agents, have proved to be effective in controlling seedborne pathogens.

Thus, there is a continuous need to arrive at new methods to inhibit plant pathogens, to increase resistance and to increase vitality of plants. There is also a further need to reduce the transplanting shock to plants for achieving the same results as stated above. There is a further need for the reduction of fertilizers and other chemical agents for achieving sustainable agricultural practices.

### OBJECT OF THE INVENTION

It is a primary object of the present invention to provide a method for controlling phytopathogenic fungi by seed treatment.

It is an object of the present invention to provide a method of seed treatment for inhibiting and/or controlling fungal plant pathogens.

It is an object of the present invention to provide an effective method of seed treatment to reduce the pesticide content required to manage a disease.

It is an object of the present invention to provide an effective method of seed treatment to reduce or eliminate the need for foliar application of fungicides.

It is another object of the present invention to provide the use of a method for inhibiting plant pathogens.

### SUMMARY OF THE INVENTION

In accordance with the object, the present invention provides a method for controlling phytopathogenic fungi by applying cyazofamid to said plant or plant propagation material or to the locus thereof.

In an aspect, the present invention provides a method for controlling phytopathogenic fungi by applying cyazofamid to a seed of a crop.

Thus, in accordance with the objective, the present invention provides a method of seed treatment for inhibiting and/or controlling fungal plant pathogens by applying cyazofamid to said plant or plant propagation material or to the locus thereof.

In an aspect, the present invention provides a method of seed treatment for inhibiting and/or controlling fungal plant pathogens by applying cyazofamid to a seed of a crop.

In accordance with another objective of the invention, the present invention provides an effective method of seed treatment to reduce the pesticide content required to manage fungal diseases in plants.

In yet another aspect, the present invention provides the use of cyazofamid for inhibiting and/or controlling fungal plant pathogens by applying cyazofamid to said plant or plant propagation material or to the locus thereof.

Additional features and advantages of the present invention will be apparent from the detailed description that follows, which illustrates by way of example, the most preferred features of the present invention which are not to be construed as limiting the scope of the invention described herein.

### DETAILED DESCRIPTION

For the purposes of the following detailed description, it is to be understood that the invention may assume various alternative variations except where expressly specified to the contrary. Moreover, other than in any operating examples, or where otherwise indicated, all numbers expressing, for example, quantities of materials/ingredients used in the specification are to be understood as being modified in all instances by the term “about”.

As used herein, the terms “comprising” “including,” “having,” “containing,” “involving,” and the like are to be understood to be open-ended, i.e., to mean including but not limited to. The terms “preferred” and “preferably” refer to embodiments of the invention that may afford certain benefits, under certain circumstances.

In any aspect or embodiment described hereinbelow, the phrase comprising may be replaced by the phrases “consisting of” or “consisting essentially of” or “consisting substantially of”. In these aspects or embodiments, the composition described includes or comprises or consists of or consists essentially of or consists substantially of the specific components recited therein, to the exclusion of other ingredients or excipients not specifically recited therein.

The term ‘plant’ refers to all physical parts of a plant, including seeds, seedlings, saplings, roots, tubers, stems, stalks, foliage and fruits. The term plant includes transgenic and non-transgenic plants.

The term “locus” of a plant as used herein is intended to embrace the place on which the plants are growing, where the plant propagation materials of the plants are sown or where the plant propagation materials of the plants will be placed into the soil.

The term “plant propagation material” refers to the parts of the plant, such as seeds, which can be used for the propagation of the plant and vegetative plant material. There may be mentioned, e.g., the seeds (in the strict sense), roots, fruits, tubers, bulbs, rhizomes as parts of plants. Germinated plants or young plants, which may be transplanted after germination or after emergence from the soil, are included herein.

The term “seed” embraces seeds and plant propagules of all kinds including but not limited to true seeds, seed pieces, suckers, corms, bulbs, fruit, tubers, grains, cuttings, cut shoots and the like. In a preferred embodiment a seed is a true seed.

The term “seeds” may also include transgenic seeds, i.e., seeds of a transgenic plant. As used herein “transgenic plant” means a plant or progeny thereof derived from a transformed plant cell or protoplast, wherein the plant DNA contains an introduced exogenous DNA molecule not originally present in a native, non-transgenic plant of the same strain

“Fungicidal” refers to the ability of a substance or a compound to decrease or inhibit or control growth and proliferation of fungi.

To “control” or “controlling” fungus means to inhibit, and/or suppress the ability of fungus to grow and/or reproduce, or to limit fungus damage or loss in crop plants or denotes control and prevention of a disease. Controlling effects include all deviation from natural development, for example: killing, retardation, decrease of the disease.

The term “locus” as used herein shall denote the vicinity of a desired crop in which control of the spread of phytopathogenic fungi is desired. The locus includes the vicinity of desired crop plants wherein the phytopathogenic fungi infection has either emerged or is most likely to emerge or is yet to emerge.

The term “plant propagation material” is understood to denote generative parts of a plant, such as seeds, vegetative material such as cuttings or tubers, roots, fruits, tubers, bulbs, rhizomes and parts of plants, germinated plants and young plants which are to be transplanted after germination or after emergence from the soil. These young plants may be protected before transplantation by a total or partial treatment by immersion.

According to the present disclosure, “increased yield” of an agricultural plant means that the yield of a product of the respective plant is increased by a measurable amount over the yield of the same product of the plant produced under the same conditions, but without the application of the compositions described herein. According to the present disclosure, it is preferred that the crop yield be increased by at least 0.5%, preferred at least 2%, more preferred at least 5%, upon application of the combinations and compositions described herein.

The inventors of the present invention have surprisingly found that when a seed coated with cyazofamid was planted, the occurrence of plant diseases considerably reduced. Hitherto, cyazofamid has not been recommended for being used for seed treatment for controlling and inhibiting fungal phytopathogens. Therefore, these advantages accruing from the use of cyazofamid in seed treatment was unexpected and surprising.

The present invention provides a method for inhibiting phytopathogenic fungi comprising applying a Quinone Inside Inhibitor (QiI), namely cyazofamid, to a plant, or a plant part or a plant propagation material or to a locus thereof.

In an embodiment, the present invention provides a method for inhibiting phytopathogenic fungi comprising applying cyazofamid to a plant, or a plant part or a plant propagation material or to a locus thereof.

In a preferred embodiment, the present invention provides a method for inhibiting phytopathogenic fungi comprising applying cyazofamid to a plant propagation material.

In another embodiment, the present invention provides a method for inhibiting phytopathogenic fungi comprising applying cyazofamid to a locus of a plant.

In an embodiment, the plant propagation material is selected from seeds, roots, fruits, tubers, bulbs, rhizomes, or germinated plants.

In an embodiment, the plant propagation material is a seed.

In an embodiment, the plant propagation material is a seed of any of the crops or plants, except soybean.

In a preferred embodiment, the present invention provides a method for inhibiting phytopathogenic fungi comprising applying cyazofamid to a propagule.

In a preferred embodiment, the present invention provides a method for inhibiting phytopathogenic fungi comprising applying cyazofamid to a crop seed.

In an embodiment, the present invention provides a method for inhibiting phytopathogenic fungi, the method comprising applying a fungicidal combination comprising cyazofamid and one or more fungicides to a seed of a crop.

In an embodiment, the fungicide is a systemic or contact fungicide.

In an embodiment, the systemic fungicide is a single fungicide or a combination of one or more systemic fungicides.

In an embodiment, the systemic fungicide is a combination of at least two fungicides.

In an embodiment, the systemic fungicides in the combinations may be selected from nucleic acid synthesis inhibitor, cytoskeleton and motor protein inhibitors, amino acids and protein synthesis inhibitors, respiration process inhibitors, signal transduction inhibitors, lipid synthesis and membrane integrity disruptors, sterol biosynthesis inhibitors, melanin synthesis inhibitors, cell wall biosynthesis inhibitors, melanin synthesis inhibitor in cell wall, host plant defence inductors, fungicides with unknown modes of action, fungicide with no classification, or biologicals with multiple mode of action.

Thus, in an embodiment, the nucleic acid synthesis inhibitor fungicides may be selected from acylalanines such as benalaxyl, benalaxyl-M (kiralaxyl), furalaxyl, metalaxyl, metalaxyl-M (mefenoxam), oxazolidinones such as oxadixyl, butyrolactones such as ofurace, hydroxy-(2-amino-) pyrimidines such as bupirimate, dimethirimol, ethirimol, isoxazoles such as hymexazole, isothiazolones such as octhilinone, carboxylic acids such as oxolinic acid.

In an embodiment, the cytoskeleton and motor protein inhibitors may be benzimidazoles such as benomyl, carbendazim, fuberidazole, thiabendazole, thiophanates such as thiophanate, thiophanate-methyl, N-phenyl carbamates such as diethofencarb, toluamides such as zoxamide, thiazole carboxamides such as ethaboxam, phenylureas such as pencycuron, benzamides such as fluopicolide, cyanoacrylates such as phenamacril.

In an embodiment, the respiration process inhibitor fungicides may be selected from pyrimidinamines such diflumetorim, pyrazole-5-carboxamides such as tolfenpyrad, strobilurins such as azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, pyribencarb and mixtures thereof, oxazolidine-diones such as famoxadone, Imidazolinones such as fenamidone, benzyl-carbamates such as pyribencarb, N-methoxy-(phenyl-ethyl)-pyrazole-carboxamides such as Pyrimidinamines such as diflumetorim, cyano-imidazole such as cyazofamid, sulfamoyl-triazole such as amisulbrom, dinitrophenyl crotonates such as binapacryl, meptyldinocap, dinocap, 2,6-dinitro-anilines such as fluazinam, pyr.-hydrazones such as ferimzone, tri-phenyl tin compounds such as fentin acetate, fentin chloride, fentin hydroxide, thiophene-carboxamides such as silthiofam, triazolo-pyrimidylamine such as ametoctradin.

In an embodiment, amino acids and protein synthesis inhibitor fungicides may be selected from anilino-pyrimidines such as cyprodinil, mepanipyrim, pyrimethanil, antibiotic fungicides such as blasticidin-S, kasugamycin, streptomycin, oxytetracycline and the like.

In an embodiment, signal transduction inhibitor fungicides may be selected from aryloxyquinolines such as quinoxyfen, quinazolinones such as proquinazid, phenylpyrroles such as fenpiclonil, fludioxonil, dicarboximides such as chlozolinate, dimethachlone, iprodione, procymidone and vinclozolin.

In an embodiment, the third fungicide may be selected from lipid synthesis and membrane integrity distruptors such as phosphoro-thiolates such as edifenphos, Iprobenfos, pyrazophos, dithiolanes such as isoprothiolane, aromatic hydrocarbons such as biphenyl, chloroneb, dicloran, quintozene (PCNB), tecnazene (TCNB), tolclofos-methyl and the like, 1,2,4-thiadiazoles such as etridiazole, carbamates such as iodocarb, propamocarb, prothiocarb and the like.

Thus in an embodiment, the sterol biosynthesis inhibitors may be selected from triazoles such as azaconazole, bitertanol, bromuconazole, cyproconazole, difenoconazole, diniconazole, epoxiconazole, etaconazole, fenbuconazole, fluquinconazole, flusilazole, flutriafol, hexaconazole, imibenconazole, Ipconazole, metconazole, myclobutanil, penconazole, Propiconazole, simeconazole, tebuconazole, tetraconazole, triadimefon, triadimenol, triticonazole, prothioconazole, piperazines such as triforine, pyridines such as pyrifenox, pyrisoxazole, pyrimidines such as fenarimol, nuarimol imidazoles such as imazalil, oxpoconazole, pefurazoate, prochloraz, triflumizole, morpholines such as aldimorph, dodemorph, fenpropimorph, tridemorph and the like, piperidines such as fenpropidin, piperalin, spiroketal-amines such as spiroxamine, hydroxyanilides such as fenhexamid, amino-pyrazolinones such as fenpyrazamine, thiocarbamates such as pyributicarb, allylamines such as naftifine, terbinafine and mixtures thereof.

In an embodiment, cell wall biosynthesis inhibitor fungicides may be selected from peptidyl pyrimidine nucleoside fungicides such as polyoxin, cinnamic acid amides such as dimethomorph, flumorph, pyrimorph, valinamide carbamates such as benthiavalicarb, iprovalicarb, valifenalate, mandelic acid amides such as mandipropamid and mixtures thereof.

In an embodiment, melanin synthesis inhibitor fungicide may be selected from isobenzo-furanone such as fthalide, pyrrolo-quinolinones such as pyroquilon, triazolobenzo-thiazoles such as tricyclazole, cyclopropane-carboxamides such as carpropamid, carboxamides such as diclocymet, propionamides such as fenoxanil, trifluoroethyl-carbamates such as tolprocarb, and mixtures thereof.

In an embodiment, host plant defence inducer fungicides may be selected from benzo-thiadiazoles such as acibenzolar-S-methyl, benzisothiazoles such as probenazole, thiadiazole-carboxamides such as tiadinil, isotianil, polysaccharides such as laminarin, and mixtures thereof.

In another embodiment, the ergosterol biosynthesis inhibitors may be selected from prothioconazole, tebuconazole, hexaconazole, cyroconazole or epoxiconazole.

In an embodiment, the systemic fungicide may be a Quinone outside (Qo) inhibitor fungicide selected from azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, trifloxystrobin, famoxadone, fluoxastrobin, fenamidone, pyribencarb and mixtures thereof.

In an embodiment, the Quinone outside (Qo) inhibitor fungicide may be selected from azoxystrobin, picoxystrobin, kresoxim-methyl, pyraclostrobin and trifloxystrobin.

In an embodiment, the multisite fungicides of the present invention may be selected from the group comprising dithiocarbamates, phthalimides, sulfamides, bis-guanidine, triazines, quinone, quinoxaline, maleimide, and thiocarbamates.

In an embodiment, one of the multisite fungicides of the present invention may be a dithiocarbamate fungicide selected from the group comprising amobam, ferbam, mancozeb, maneb, metiram, propineb, thiram, zinc thiazole, zineb and ziram.

In an embodiment, one of the multisite fungicides of the present invention may be a phthalimide fungicide selected from the group comprising captan, captafol and folpet.

In an embodiment, one of the multisite fungicides of the present invention may be cholorothalonil.

In an embodiment, one of the multisite fungicides of the present invention may be a sulfamide fungicide selected from dichlofluanid and tolylfluanid.

In an embodiment, one of the multisite fungicides of the present invention may be a bis-guanidine fungicide selected from guazatine and iminoctadine.

In an embodiment, one of the multisite fungicides of the present invention may be a triazine fungicide selected from anilazine.

In an embodiment, one of the multisite fungicides of the present invention may be a quinone fungicide selected from dithianon.

In an embodiment, one of the multisite fungicides of the present invention may be a quinoxaline fungicide selected from chinomethionat or quinomethionate.

In an embodiment, one of the multisite fungicides of the present invention may be a maleimide fungicide selected from fluoroimide.

In an embodiment, one of the multisite fungicides of the present invention may be a thiocarbamate fungicide selected from methasulfocarb.

In the practice of the present invention, cyazofamid may be employed in the form of technical material or in the form of any standard agriculturally acceptable formulation.

The composition that is used to treat seeds in the present disclosure is in the form of a soluble concentrate (SL, LS), a dispersible concentrate (DC), an emulsifiable concentrate (EC), a suspension (SC, OD, FS), an emulsion (EW, EO, ES), a slurry of particles in an aqueous medium (e.g. water), a paste, a water-dispersible or water-soluble powder (WP, SP, SS, WS), a pastille, a water-dispersible or water-soluble granule (WG, SG), a dry granule (GR, FG, GG, MG), a gel formulation (GF) and a dustable powder (DP, DS). Water-soluble concentrates (LS), flowable concentrates (FS), powders for dry treatment (DS), water-dispersible powders for slurry treatment (WS), water-soluble powders (SS), emulsions (ES), emulsifiable concentrates (EC) and gels (GF) are usually employed for the purposes of treatment of seeds.

In an embodiment, cyazofamid is formulated as an agrochemical composition as formulation comprising a suspension concentrate (SC), an emulsifiable concentrate (EC), a flowable concentrate (FS), a Microemulsion (ME), an Oil Dispersion (OD), a Suspoemulsion (SE) and the like.

In an embodiment cyazofamid is coated on the surface of a seed or a plant part or a plant propagation material or a plant propagule in the form of a suspension concentrate, emulsifiable concentrate or any other suitable liquid formulation that can coat the seed or plant or plant propagation material.

In an embodiment, a suspension concentrate (SC) formulation comprising cyazofamid is used.

In a preferred embodiment, a flowable concentrate (FS) formulation comprising cyazofamid is used.

In an embodiment, the present invention provides an aqueous formulation comprising cyazofamid in a concentration ranging from 1% w/v to 80% w/v.

In an embodiment, the present invention provides an aqueous formulation comprising cyazofamid in a concentration ranging from 10% w/v to 60% w/v.

In an embodiment, the present invention provides an aqueous formulation comprising cyazofamid in a concentration ranging from 20% w/v to 50% w/v.

In an embodiment, the present invention provides an aqueous formulation comprising cyazofamid in a concentration ranging from 30% w/v to 50% w/v.

In an embodiment, the present invention provides an aqueous formulation comprising cyazofamid in a concentration of 40% w/v.

In an embodiment, the present invention provides a suspension concentrate formulation comprising cyazofamid in a concentration ranging from 1% w/v to 80% w/v.

In an embodiment, the present invention provides a suspension concentrate formulation comprising cyazofamid in a concentration ranging from 10% w/v to 60% w/v.

In an embodiment, the present invention provides a suspension concentrate formulation comprising cyazofamid in a concentration ranging from 20% w/v to 50% w/v.

In an embodiment, the present invention provides a suspension concentrate formulation comprising cyazofamid in a concentration ranging from 30% w/v to 50% w/v.

In an embodiment, the present invention provides a suspension concentrate formulation comprising cyazofamid in a concentration of 40% w/v.

In an embodiment, the present invention provides a flowable concentrate formulation comprising cyazofamid in a concentration ranging from 1% w/v to 80% w/v.

In an embodiment, the present invention provides a flowable concentrate formulation comprising cyazofamid in a concentration ranging from 10% w/v to 60% w/v.

In an embodiment, the present invention provides a flowable concentrate formulation comprising cyazofamid in a concentration ranging from 20% w/v to 50% w/v.

In an embodiment, the present invention provides a flowable concentrate formulation comprising cyazofamid in a concentration ranging from 30% w/v to 50% w/v.

In an embodiment, the present invention provides a flowable concentrate formulation comprising cyazofamid in a concentration of 40% w/v.

In an embodiment, the present invention provides a method for inhibiting phytopathogenic fungi, the method comprising applying to a seed crop, a suspension concentrate formulation comprising cyazofamid and at least one agriculturally acceptable excipient.

In an embodiment, the present invention provides a method for inhibiting phytopathogenic fungi, the method comprising applying to a seed crop, a flowable concentrate formulation comprising cyazofamid and at least one agriculturally acceptable excipient.

In an embodiment, the agrochemically acceptable excipient are selected from the group consisting of surfactants, antifreeze agents, wetting agents, antifoaming agents, thickening agents, preservatives, colorants, fillers, and combinations thereof.

In an embodiment the formulation includes a surfactant mix comprising a non-ionic surfactant and an anionic surfactant.

In an embodiment of the present invention, the non-ionic surfactant comprises nonionic surfactants such as polyalkyleneoxide siloxanes, ethoxylated derivatives of fatty alcohols, alkyl glucosides, alkyl phenols, polyalkylene glycol ethers and condensation products of alkyl phenols, amines, fatty acids, fatty esters, mono-, di, or triglycerides, various block copolymeric surfactants derived from alkylene oxides such as ethylene oxide/propylene oxide, aliphatic amines or fatty acids with ethylene oxides and/or propylene oxides such as the ethoxylated alkyl phenols or ethoxylated aryl or polyaryl phenols, carboxylic esters solubilized with a polyol or polyvinyl alcohol/polyvinyl acetate copolymers, polyvinyl alcohol, polyvinyl pyrrolidinones and acrylic acid graft copolymers and mixtures, reaction products, and/or copolymers thereof and combinations thereof.

In a preferred embodiment, non-ionic surfactant of surfactant mix comprises various block copolymeric surfactants derived from alkylene oxides such as ethylene oxide/propylene oxide, aliphatic amines or fatty acids with ethylene oxides and/or propylene oxides such as the ethoxylated alkyl phenols or ethoxylated aryl or polyaryl phenols, their mixtures, reaction products, and/or copolymers thereof and combinations thereof.

In an embodiment, the composition comprises from about 0.1% to about 50% w/w and preferably from about 1% to about 40% w/w non-ionic surfactant of the total weight of the agrochemical composition.

In an embodiment, the anionic surfactant comprises alkyl and aryl sulfates and sulfonates, including sodium alky sulfates, sodium mono- and di-alkyl naphthalene sulfonates, sodium alpha-olefin sulfonate, lignin and its derivatives (such as lignosulfonate salts), sodium alkane sulfonates, polyoxyalkyene alkylether sulfate, polyoxyalkylene alkylaiyl ether sulfates, polyoxy-alkylene styrylphenyl ether sulfate, mono- and di-alkylbenzene sulfonates, alkylnaphthalene sulfonate, alkylnaphthalene sulfonate formaldehyde condensate, alkyl diphenylether sulfonates, olefme sulfonates, alkylphosphates, polyoxyalkylene alkyl phosphates, polyoxyalkylene phenylether phosphate, polyoxyalkylphenol phosphates, poly-carboxylates, fatty acids and salts thereof, alkyl glycinates, sulfonated methyl esters, sulfonated fatty acids, sulfosuccinates and their derivatives, acyl glutamates, acyl sarcosinates, alkyl sulfoacetates, acylated peptides, alkyl ether carboxylates, acyl lactylates, anionic fluorosurfactants, amid ether sulfates, N-methyl fatty acid taurides, mixtures thereof and the like, including sodium, potassium, ammonium and amine salts, etc. or mixtures thereof.

In a preferred embodiment, the anionic surfactant comprises alkyl and aryl sulfates and sulfonates, including sodium alky sulfates, sodium mono- and di-alkyl naphthalene sulfonates, lignin and its derivatives (such as lignosulfonate salts), polyoxyalkyene alkylether sulfate, alkylnaphthalene sulfonate, alkylnaphthalene sulfonate formaldehyde condensate and combinations thereof.

In an embodiment, the composition comprises from about 0.1% to about 50% w/w and preferably from about 1% to about 40% w/w anionic surfactant of the total weight of composition.

In an embodiment the composition may further comprise one or more antifreeze agent, wetting agents, fillers, anticaking agents, pH-regulating agents, preservatives, biocides, antifoaming agents, colorants and other formulation aids.

Suitable antifreeze agents that can be added to the agrochemical composition are liquid polyols, for example ethylene glycol, propylene glycol or glycerol.

Wetting agents that can be added to the agrochemical composition of the present invention include, but are not limited to: polyarylalkoxylated phosphate esters and their potassium salts (e.g., Soprophor® FLK, Stepfac TSP PE-K. Other suitable wetting agents include sodium dioctylsulfosuccinates (e.g., Geropon® SDS, Aerosol® OT) and ethoxylated alcohols (e.g., Trideth-6; Rhodasurf® BC 610; Tersperse® 4894).

Optionally, about 0.1 wt % to about 5.0 wt % of antifoaming or defoamers are employed to stop any unwanted foam generated while manufacturing highly concentrated liquid biocide dispersion composition. The preferred antifoaming agent is selected from the group of silicone-based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination. Defoamers that are suitable include SAG-10; SAG-1000AP; SAG-1529; SAG-1538; SAG-1571; SAG-1572; SAG-1575; SAG-2001; SAG-220; SAG-290; SAG-30; SAG-30E; SAG-330; SAG-47; SAG-5440; SAG-7133 and SAG-770.

Examples of thickening agents based on anionic heteropolysaccharides from the xanthan gum group are inter alia the Rhodopol 23®, Rhodopol G®, Rhodopol 50 MD®, Rhodicare T®, Kelzan®, Kelzan S® and Satiaxane CX91®.

Preservatives used may be benzisothiazolinone (Proxel GXL) or phonols, 2-bromo-2-nitropropane-1,3-diol (Bioban BP 30), 5-chloro-2-methyl-4-isothiazolin-3-one & 2 methyl-4-isothiazolin-3 one (Kathon CG/ICP), Glutaraldehyde (Ucarcide 50), Chloromethylisothiazolinone (CMIT)/Methylisothiazolinone (MIT) (Isocil Ultra 1.5), 2.2-dibromo-3-nitrilopropioamide (Reputain 20), Natamycin & Nisin, Bronopol/CMIT/MIT (Mergal 721K3).

Suitable colorants (for example in red, blue and green) are, preferably, pigments, which are sparingly soluble in water, and dyes, which are water-soluble. Examples are inorganic coloring agents (for example iron oxide, titanium oxide, and iron hexacyanoferrate) and organic coloring agents (for example alizarin, azo and phthalocyanin coloring agents).

Fillers may include an organic or inorganic solid inert substance such as talc, clay, diatomaceous earth, magnesium aluminum silicate, white carbon black, pyrophyllite, light calcium carbonate, high clay, organic bentonite, etc. and mixtures thereof.

In an embodiment, the method of the present invention provides one, or more than one, or all of these advantages by applying cyazofamid to either the plant, or to the plant propagation material, or to the locus of plant growth or intended plant growth.

In an embodiment, the present invention provides a method for controlling or inhibiting phytopathogenic fungi comprising contacting cyazofamid with said plant or plant part or plant propagation material or to the locus thereof.

In an embodiment, the present invention provides a method for controlling or inhibiting phytopathogenic fungi comprising contacting cyazofamid with said plant or plant part or plant propagation material or to the locus thereof.

The method of the present invention may be used to control a broad spectrum of plant diseases, such as:

Disease in rice: Blast (Magnaporthe grisea), Helminthosporium leaf spot (Cochliobolus miyabeanus), sheath blight (Rhizoctonia solani), and bakanae disease (Gibberella fujikuroi).

Diseases in wheat: powdery mildew (Erysiphe graminis), Fusarium head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis).

Diseases of barley: powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).

Diseases in corn: smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis) and Rhizoctonia damping-off (Rhizoctonia solani).

Diseases of citrus: melanose (Diaporthe citri), scab (Elsinoe fawcetti), penicillium rot (Penicillium digitatum, P. italicum), and brown rot (Phytophthora parasitica, Phytophthora citrophthora).

Diseases of apple: blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear: scab (Venturia nashicola, V. pirina), powdery mildew, black spot (Alternaria alternata Japanese pear pathotype), rust (Gymnosporangium haraeanum), and phytophthora fruit rot (Phytophtora cactorum).

Diseases of peach: brown rot (Monilinia fructicola), powdery mildew, scab (Cladosporium carpophilum), and phomopsis rot (Phomopsis sp.).

Diseases of grape: anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of Japanese persimmon: anthracnose (Gloeosporium kaki), and leaf spot (Cercospora kaki, Mycosphaerella nawae).

Diseases of gourd: anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp.).

Diseases of tomato: early blight (Alternaria solani), leaf mold (Cladosporium fulvum), and late blight (Phytophthora infestans).

Diseases of eggplant: brown spot (Phomopsis vexans), and powdery mildew (Erysiphe cichoracearum) Diseases of cruciferous vegetables: Alternaria leaf spot (Alternaria japonica), white spot (Cercosporella brassicae), clubroot (Plasmodiophora brassicae), and downy mildew (Peronospora parasitica).

Diseases of onion: rust (Puccinia allii), and downy mildew (Peronospora destructor)

Diseases of kidney bean: anthracnose (Colletotrichum lindemthianum). Diseases of peanut: leaf spot (Cercospora personata), brown leaf spot (Cercospora arachidicola) and southern blight (Sclerotium rolfsii).

Diseases of garden pea: powdery mildew (Erysiphe pisi), and root rot (Fusarium solani f. sp. pisi).

Diseases of potato: early blight (Alternaria solani), late blight (Phytophthora infestans), pink rot (Phytophthora erythroseptica), and powdery scab (Spongospora subterranean f sp. subterranea).

Diseases of strawberry: powdery mildew (Sphaerotheca humuli), and anthracnose (Glomerella cingulata).

Diseases of tea: net blister blight (Exobasidium reticulatum), white scab (Elsinoe leucospila), gray blight (Pestalotiopsis sp.), and anthracnose (Colletotrichum theae-sinensis).

Diseases of tobacco: brown spot (Alternaria longipes), powdery mildew (Erysiphe cichoracearum), anthracnose (Colletotrichum tabacum), downy mildew (Peronospora tabacina), and black shank (Phytophthora nicotianae).

Diseases of rapeseed: sclerotinia rot (Sclerotinia sclerotiorum), and Rhizoctonia damping-off (Rhizoctonia solani). Diseases of cotton: Rhizoctonia damping-off (Rhizoctonia solani).

Diseases of sugar beet: Cercospora leaf spot (Cercospora beticola), leaf blight (Thanatephorus cucumeris), Root rot (Thanatephorus cucumeris), and Aphanomyces root rot (Aphanomyces cochioides).

Diseases of legumes purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi), Yellow rust, brown stem rot (Phytophthora sojae), and Rhizoctonia damping-off (Rhizoctonia solani).

Diseases of rose: black spot (Diplocarpon rosae), powdery mildew (Sphaerotheca pannosa), and downy mildew (Peronospora sparsa). Diseases of chrysanthemum and asteraceous plants: downy mildew (Bremia lactucae), leaf blight (Septoria chrysanthemi-indici), and white rust (Puccinia horiana).

Diseases of various groups: diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).

Disease of Japanese radish: Alternaria leaf spot (Alternaria brassicicola).

Diseases of turfgrass: dollar spot (Sclerotinia homeocarpa), and brown patch and large patch (Rhizoctonia solani).

Disease of banana: Black sigatoka (Mycosphaerella fijiensis), Yellow sigatoka (Mycosphaerella musicola).

Disease of sunflower: downy mildew (Plasmopara halstedii).

Seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants mediated by Polymixa spp. or Olpidium spp. and so on.

The compositions of present invention may be applied to the locus of the plant on one or more occasions during the growth of the plant. It can be applied to the planting site before the seed is sown, during the sowing of the seed, pre-emergence and/or post-emergence. The compositions can also be used while the plant is being grown in a green house and the use can be continued after transplantation. The soil may, for example, be treated directly, prior to transplanting, at transplanting or after transplanting. The use of the compositions can be via any suitable method, which ensures that the agents penetrate the soil, for example, nursery tray application, in furrow application, soil drenching, soil injection, drip irrigation, application through sprinklers or central pivot, incorporation into soil (broad cast or in band) are such methods.

The treatment according to the invention of the plants and plant parts with the active compound or its compositions is carried out directly or by action on their surroundings, habitat or storage space using customary treatment methods, for example by dipping, spraying, atomizing, irrigating, evaporating, dusting, fogging, broadcasting, foaming, painting, spreading-on, watering (drenching), drip irrigating and, in the case of propagation material, in particular in the case of seeds, furthermore as a powder for dry seed treatment, a solution for seed treatment, a water-soluble powder for slurry treatment, by incrusting, by coating with one or more layers, etc. It is furthermore possible to apply the active compound in combination with other active(s) by the ultra-low volume method, or to inject the active compound combination into the soil.

Preferred plants which may be treated in the process of this invention include brassicas, such as broccoli, Chinese broccoli, Brussels sprouts, cauliflower, Cavalo broccoli, kohlrabi, cabbage, Chinese cabbage and Chinese mustard cabbage; cilantro; coriander; corn, cucurbits, such as chayote, Chinese waxgourd, citron melon, cucumber, gherkin, gourd, muskmelons (including cantaloupe, casaba, crenshaw melon, golden pershaw melon, honeydew melon, honey balls, mango melon, Persian melon, pineapple melon, Santa Claus melon and snake melon), pumpkins, summer squash, winter squash and watermelon; dried beans and peas, including bean, field bean, kidney bean, lima bean, pinto bean, navy bean, tepary bean, adzuki bean, blackeyed pea, catjang, cowpea, crowder pea, moth bean, mung bean, rice bean, southern pea, urd bean, broad bean, chickpea, guar, lablab bean, lentil, pea, field pea and pigeon pea; eggplant; lettuce; leafy brassicas/turnip greens including broccoli raab, bok choy, collards, kale, mizuna, mustard spinach, rape greens and turnip greens; okra; peppers; sod; spinach; succulent peas and beans including pea, dwarf pea, edible-pod pea, English pea, garden pea, green pea, snow pea, sugar snap pea, pigeon pea, bean, broad bean, lima bean, runner bean, snap bean, wax bean, asparagus bean, yardlong bean, jackbean and sword bean; tobacco; tomatoes; and tuberous and corm vegetables including potato, sweet potato, arracacha, arrowroot, Chinese artichoke, Jerusalem artichoke, edible canna, cassava, chayote, chufa, dasheen, ginger, leren, tanier, turmer, yam bean and true yam.

The rate and frequency of use of the compositions on the plant may vary within wide limits and depends on the type of use, the specific active agents, the nature of the soil, the method of application (pre- or post-emergence, etc.), the plant, the prevailing climatic conditions, and other factors governed by the method of application, the time of application and the target plant.

In an embodiment, when employed in plant protection, the amount of active substance applied is in the range, depending on the kind of effect desired, from 0.001 to 10 kg per ha, preferably from 0.001 to 5 kg per ha or 0.001 to 2 kg per ha preferably from 0.005 to 1 kg per ha, in particular from 0.005 to 0.5 kg per ha.

Accordingly, the rates of application of cyazofamid may vary, according to type of crop, the specific active ingredient, the number of active ingredients, type of plant propagation material but is such that the active ingredient(s) (a.i.) is in an effective amount to provide the desired action (such as disease or pest control) and can be determined by trials.

In an embodiment, for seed treatment, application rates of cyazofamid can vary from 0.1 pg to 100 mg, preferably 0.5 pg to 50 mg, more preferably 1 μg to 10 mg, especially 0.1 to 2 mg, of a. i./seed.

In an embodiment, for seed treatment, application rates of cyazofamid can vary from 1 g to 300 g of active ingredient (a.i.)/100 kg seed, preferably 5 g to 250 g of a.i./100 kg seed, more preferably 10 g to 200 g of a.i./100 kg seed.

Preferably, the amount of pesticide or other ingredients used in the seed treatment should not inhibit generation of the seed or cause phytotoxic damage to the seed.

In an embodiment, the seed which is treated with cyazofamid is selected from corn, cotton, oilseeds.

In an embodiment, the seed which is treated with cyazofamid is corn.

In an embodiment of each aspect, application rate of cyazofamid is from 0.2 to 1.5 mg ai/seed, especially on a cotton seed.

In an embodiment of each aspect, application rate of cyazofamid is from 0.2 to 1.5 mg ai/seed, especially on a corn seed.

In an embodiment of each aspect, application rate of cyazofamid is from 0.2 to 1.5 mg ai/seed, especially on an oil seed.

In an embodiment of each aspect, application rate of cyazofamid is from 1 g to 500 g of a.i./100 kg seed, especially on a cotton seed.

In an embodiment of each aspect, application rate of cyazofamid is from 1 g to 500 g of a.i./100 kg seed, especially on a corn seed.

In an embodiment of each aspect, application rate of cyazofamid is from 1 g to 500 g of a.i./100 kg seed, especially on an oil seed.

In an embodiment of each aspect, application rate of cyazofamid is from 5 g to 250 g of a.i./100 kg seed, especially on a cotton seed.

In an embodiment of each aspect, application rate of cyazofamid is from 5 g to 250 g of a.i./100 kg seed, especially on a corn seed.

In an embodiment of each aspect, application rate of cyazofamid is from 5 g to 250 g of a.i./100 kg seed, especially on an oil seed.

In an embodiment, the present invention provides a method of controlling or inhibiting fungal phytopathogens, comprising applying an effective amount of cyazofamid to a plant propagation material, wherein cyazofamid is applied at a concentration of 1 g to 500 g of a.i./100 kg seed.

In an embodiment, the present invention provides a method of controlling or inhibiting fungal phytopathogens, comprising applying an effective amount of cyazofamid to a plant propagation material, wherein cyazofamid is applied at a concentration of 5 g to 250 g of a.i./100 kg seed.

In an embodiment, the present invention provides a method of controlling or inhibiting fungal phytopathogens, comprising applying an effective amount of cyazofamid to a plant propagation material, wherein cyazofamid is applied at a concentration of 10 g to 200 g of a.i./100 kg seed.

In an embodiment, the present invention provides a method of controlling or inhibiting Plasmopara sp., comprising applying an effective amount of cyazofamid to a seed, wherein cyazofamid is applied at a concentration of 1 g to 500 g of a.i./100 kg seed.

In an embodiment, the present invention provides a method of controlling or inhibiting Plasmopara sp., comprising applying an effective amount of cyazofamid to a seed, wherein cyazofamid is applied at a concentration of 5 g to 250 g of a.i./100 kg seed.

In an embodiment, the present invention provides a method of controlling or inhibiting Plasmopara sp., comprising applying an effective amount of cyazofamid to a seed, wherein cyazofamid is applied at a concentration of 10 g to 200 g of a.i./100 kg seed.

In an embodiment, the present invention provides a method of controlling or inhibiting Plasmopara halstedii, comprising applying an effective amount of cyazofamid to a seed, wherein cyazofamid is applied at a concentration of 1 g to 500 g of a.i./100 kg seed.

In an embodiment, the present invention provides a method of controlling or inhibiting Plasmopara halstedii, comprising applying an effective amount of cyazofamid to a seed, wherein cyazofamid is applied at a concentration of 5 g to 250 g of a.i./100 kg seed.

In an embodiment, the present invention provides a method of controlling or inhibiting Plasmopara halstedii, comprising applying an effective amount of cyazofamid to a seed, wherein cyazofamid is applied at a concentration of 10 g to 200 g of a.i./100 kg seed.

In an embodiment, the present invention provides a method of controlling or inhibiting Plasmopara halstedii, comprising applying an effective amount of cyazofamid to a sunflower seed, wherein cyazofamid is applied at a concentration of 1 g to 500 g of a.i./100 kg seed.

In an embodiment, the present invention provides a method of controlling or inhibiting Plasmopara halstedii, comprising applying an effective amount of cyazofamid to a sunflower seed, wherein cyazofamid is applied at a concentration of 5 g to 250 g of a.i./100 kg seed.

In an embodiment, the present invention provides a method of controlling or inhibiting Plasmopara halstedii, comprising applying an effective amount of cyazofamid to a sunflower seed, wherein cyazofamid is applied at a concentration of 10 g to 200 g of a.i./100 kg seed.

In an embodiment, the present invention provides a method of controlling or inhibiting Pythium spp., comprising applying an effective amount of cyazofamid to a seed, wherein cyazofamid is applied at a concentration of 1 g to 500 g of a.i./100 kg seed.

In an embodiment, the present invention provides a method of controlling or inhibiting Pythium spp., comprising applying an effective amount of cyazofamid to a seed, wherein cyazofamid is applied at a concentration of 5 g to 250 g of a.i./100 kg seed.

In an embodiment, the present invention provides a method of controlling or inhibiting Pythium spp., comprising applying an effective amount of cyazofamid to a seed, wherein cyazofamid is applied at a concentration of 10 g to 200 g of a.i./100 kg seed.

In an embodiment, the present invention provides a method of controlling or inhibiting Pythium ultimum, comprising applying an effective amount of cyazofamid to a seed, wherein cyazofamid is applied at a concentration of 1 g to 500 g of a.i./100 kg seed.

In an embodiment, the present invention provides a method of controlling or inhibiting Pythium ultimum, comprising applying an effective amount of cyazofamid to a seed, wherein cyazofamid is applied at a concentration of 5 g to 250 g of a.i./100 kg seed.

In an embodiment, the present invention provides a method of controlling or inhibiting Pythium ultimum, comprising applying an effective amount of cyazofamid to a seed, wherein cyazofamid is applied at a concentration of 10 g to 200 g of a.i./100 kg seed.

In an embodiment, the present invention provides a method of controlling or inhibiting Pythium ultimum, comprising applying an effective amount of cyazofamid to a seed of crops selected from corn, cotton, oilseed crops, wheats, rice and such other crops, wherein cyazofamid is applied at a concentration of 10 g to 200 g of a.i./100 kg seed.

In an embodiment, the present invention provides a method of controlling or inhibiting Phytophthora spp., comprising applying an effective amount of cyazofamid to a seed, wherein cyazofamid is applied at a concentration of 1 g to 500 g of a.i./100 kg seed.

In an embodiment, the present invention provides a method of controlling or inhibiting Phytophthora spp., comprising applying an effective amount of cyazofamid to a seed, wherein cyazofamid is applied at a concentration of 5 g to 250 g of a.i./100 kg seed.

In an embodiment, the present invention provides a method of controlling or inhibiting Phytophthora spp., comprising applying an effective amount of cyazofamid to a seed, wherein cyazofamid is applied at a concentration of 10 g to 200 g of a.i./100 kg seed.

In an embodiment, the present invention provides a method of controlling or inhibiting Phytophthora spp., comprising applying an effective amount of cyazofamid to a seed of crops selected from corn, cotton, oilseed crops, wheats, rice and such other crops, wherein cyazofamid is applied at a concentration of 1 g to 500 g of a.i./100 kg seed.

In an embodiment, the present invention provides a method of controlling or inhibiting Phytophthora spp., comprising applying an effective amount of cyazofamid to a seed of crops selected from corn, cotton, oilseed crops, wheats, rice and such other crops, wherein cyazofamid is applied at a concentration of 5 g to 250 g of a.i./100 kg seed.

In an embodiment, the present invention provides a method of controlling or inhibiting Phytophthora spp., comprising applying an effective amount of cyazofamid to a seed of crops selected from corn, cotton, oilseed crops, wheats, rice and such other crops, wherein cyazofamid is applied at a concentration of 10 g to 200 g of a.i./100 kg seed.

In an embodiment, the present invention provides a method of controlling or inhibiting Phytophthora sojae comprising applying an effective amount of cyazofamid to a seed, wherein cyazofamid is applied at a concentration of 1 g to 500 g of a.i./100 kg seed.

In an embodiment, the present invention provides a method of controlling or inhibiting Phytophthora sojae comprising applying an effective amount of cyazofamid to a seed, wherein cyazofamid is applied at a concentration of 5 g to 250 g of a.i./100 kg seed.

In an embodiment, the present invention provides a method of controlling or inhibiting Phytophthora sojae comprising applying an effective amount of cyazofamid to a seed, wherein cyazofamid is applied at a concentration of 10 g to 200 g of a.i./100 kg seed.

In an embodiment, the present invention provides a method of controlling or inhibiting Phytophthora sojae comprising applying an effective amount of cyazofamid to a seed of crops selected from corn, cotton, oilseed crops, wheats, rice and such other crops, wherein cyazofamid is applied at a concentration of 1 g to 500 g of a.i./100 kg seed.

In an embodiment, the present invention provides a method of controlling or inhibiting Phytophthora sojae comprising applying an effective amount of cyazofamid to a seed of crops selected from corn, cotton, oilseed crops, wheats, rice and such other crops, wherein cyazofamid is applied at a concentration of 5 g to 250 g of a.i./100 kg seed.

In an embodiment, the present invention provides a method of controlling or inhibiting Phytophthora sojae comprising applying an effective amount of cyazofamid to a seed of crops selected from corn, cotton, oilseed crops, wheats, rice and such other crops, wherein cyazofamid is applied at a concentration of 10 g to 200 g of a.i./100 kg seed.

In embodiment, the coating of the plant or plant propagation material or seed can be done by any method known in the art.

In a preferred embodiment the plant or plant propagation material or seed is sown or planted in the soil or pots or nurseries.

In a preferred embodiment the sowing of plant or plant propagation material or seed is done by line sowing.

The seed treatment composition can also comprise or may be applied together and/or sequentially with further active compounds. These further compounds can be selected from fertilizers or micronutrient donors or microorganisms or other preparations that influence plant growth, such as inoculants (e.g. a strain of nitrogen-fixing bacteria), plant inducers.

In an embodiment, the method of the present invention increases the disease resistance in a plant or plant propagation material.

The plant propagation material treated with cyazofamid in the first aspect are, therefore, resistant to disease and/or pest damage; accordingly, the present invention also provides a pathogenic and/or pest resistant plant propagation material which is treated with cyazofamid and one or further active compounds and consequently at least the active ingredients thereof are adhered on the propagation material, such a seed.

Therefore, in yet another embodiment, the present invention provides a plant treated with cyazofamid.

In yet another embodiment, the present invention provides a plant treated with cyazofamid, such that at least a portion of the applied cyazofamid is adhered to the plant or a portion thereof.

In yet another embodiment, the present invention provides a plant propagation material treated with cyazofamid.

In yet another embodiment, the present invention provides a propagule treated with cyazofamid.

In an embodiment, the present invention provides a plant propagation material treated with cyazofamid, such that at least a portion of the applied cyazofamid is adhered to the plant propagation material.

In an embodiment, the plant propagation material is a seed.

Thus, in an embodiment, the present invention provides a seed treated with cyazofamid.

In another embodiment, the present invention provides a seed treated with cyazofamid, such that at least a portion of the applied cyazofamid is adhered to the plant propagation material.

In an embodiment, the seed may be a fruit seed or vegetable seed.

In an embodiment, the choice of the selected seed is not limiting.

In an embodiment, the seed may be selected from orange seed, raspberries seed, broccoli seed, prune seed, corn seed, bean seed, peach seed, mango seed, celery seed, conifer seed, tangerine seed, kiwifruit seed, gooseberry seed, plum seed, pumpkin seed, starfruit seed, bean seed, carrot seed, asparagus seed, apple seed, crab apple seed, swiss chard seed, and many more.

Therefore, in yet another embodiment, the present invention provides a corn plant treated with cyazofamid.

In yet another embodiment, the present invention provides a corn plant treated with cyazofamid, such that at least a portion of the applied cyazofamid is adhered to the corn plant or a portion thereof.

In yet another embodiment, the present invention provides a corn plant propagation material treated with cyazofamid.

In an embodiment, the present invention provides a corn plant propagation material treated with cyazofamid, such that at least a portion of the applied cyazofamid is adhered to the corn plant propagation material.

In an embodiment, the corn plant propagation material is a corn seed.

Thus, in an embodiment, the present invention provides a corn seed treated with cyazofamid.

In another embodiment, the present invention provides a corn seed treated with cyazofamid, such that at least a portion of the applied cyazofamid is adhered to the corn seed.

In yet another embodiment, the present invention provides a sunflower plant treated with cyazofamid, such that at least a portion of the applied cyazofamid is adhered to the corn plant or a portion thereof.

In yet another embodiment, the present invention provides a sunflower plant propagation material treated with cyazofamid.

In an embodiment, the present invention provides a sunflower plant propagation material treated with cyazofamid, such that at least a portion of the applied cyazofamid is adhered to the corn plant propagation material.

In an embodiment, the corn plant propagation material is a sunflower seed.

Thus, in an embodiment, the present invention provides a sunflower seed treated with cyazofamid.

In another embodiment, the present invention provides a sunflower seed treated with cyazofamid, such that at least a portion of the applied cyazofamid is adhered to the sunflower seed.

In yet another embodiment, the present invention provides a cotton plant treated with cyazofamid, such that at least a portion of the applied cyazofamid is adhered to the corn plant or a portion thereof.

In yet another embodiment, the present invention provides a cotton plant propagation material treated with cyazofamid.

In an embodiment, the present invention provides a cotton plant propagation material treated with cyazofamid, such that at least a portion of the applied cyazofamid is adhered to the corn plant propagation material.

In an embodiment, the corn plant propagation material is a cotton seed.

Thus, in an embodiment, the present invention provides a cotton seed treated with cyazofamid.

In another embodiment, the present invention provides a cotton seed treated with cyazofamid, such that at least a portion of the applied cyazofamid is adhered to the sunflower seed.

In an embodiment, the present invention provides corn seeds treated with cyazofamid, wherein cyazofamid is applied at a rate of at least 5 g/100 kg seeds to 500 g/100 kg seeds.

In an embodiment, the present invention provides corn seeds treated with cyazofamid, wherein cyazofamid is applied at a rate of at least 10 g/100 kg seeds to 200 g/100 kg seeds.

In an embodiment, the present invention provides a corn seed treated with cyazofamid, wherein cyazofamid is applied at a rate of at least 5 g per mL of cyazofamid per kg of corn seed.

In an embodiment, the present invention provides a corn seed treated with cyazofamid, wherein cyazofamid is applied at a rate of at least 5 g per mL of cyazofamid per kg of corn seed, such that complete inhibition of fungal pathogen is observed, within 5 to 15 days of sowing seeds.

In an embodiment, the present invention provides a corn seed treated with cyazofamid, wherein cyazofamid is applied at a rate of at least 10 g per mL of cyazofamid per kg of corn seed.

In an embodiment, the present invention provides a corn seed(s) treated with cyazofamid, wherein cyazofamid is applied at a rate of at least 10 g per mL of cyazofamid per kg of corn seed, such that complete inhibition of fungal pathogen is observed, within 5 to 15 days of sowing seeds.

In an embodiment, the present invention provides sunflower seeds treated with cyazofamid, wherein cyazofamid is applied at a rate of at least 5 g/100 kg seeds to 500 g/100 kg seeds.

In an embodiment, the present invention provides sunflower seeds treated with cyazofamid, wherein cyazofamid is applied at a rate of at least 10 g/100 kg seeds to 200 g/100 kg seeds.

In an embodiment, the present invention provides a sunflower seed(s) treated with cyazofamid, wherein cyazofamid is applied at a rate of at least 10 g per mL of cyazofamid per kg of corn seed, such that complete inhibition of fungal pathogen is observed, within 5 to 15 days of sowing seeds.

In an embodiment, the present invention provides cotton seeds treated with cyazofamid, wherein cyazofamid is applied at a rate of at least 5 g/100 kg seeds to 500 g/100 kg seeds.

In an embodiment, the present invention provides cotton seeds treated with cyazofamid, wherein cyazofamid is applied at a rate of at least 10 g/100 kg seeds to 200 g/100 kg seeds.

In an embodiment, the present invention provides a cotton seed(s) treated with cyazofamid, wherein cyazofamid is applied at a rate of at least 10 g per mL of cyazofamid per kg of corn seed, such that complete inhibition of fungal pathogen is observed, within 5 to 15 days of sowing seeds.

In an embodiment, the present invention provides rice grain(s) treated with cyazofamid, wherein cyazofamid is applied at a rate of at least 5 g/100 kg seeds to 500 g/100 kg seeds.

In an embodiment, the present invention provides rice grain(s) treated with cyazofamid, wherein cyazofamid is applied at a rate of at least 10 g/100 kg seeds to 200 g/100 kg seeds.

In an embodiment, the present invention provides a rice grain(s) treated with cyazofamid, wherein cyazofamid is applied at a rate of at least 10 g per mL of cyazofamid per kg of corn seed, such that complete inhibition of fungal pathogen is observed, within 5 to 15 days of sowing seeds.

In an embodiment, the present invention provides wheat cereals treated with cyazofamid, wherein cyazofamid is applied at a rate of at least 5 g/100 kg seeds to 500 g/100 kg seeds.

In an embodiment, the present invention provides wheat cereals treated with cyazofamid, wherein cyazofamid is applied at a rate of at least 10 g/100 kg seeds to 200 g/100 kg seeds.

In yet another embodiment, the present invention provides a locus treated with cyazofamid, wherein the locus is planted with or intended to be planted with a plant or a plant propagation material.

In another embodiment, the present invention provides a method of treating a locus comprising applying cyazofamid to the locus which is planted with or intended to be planted with a plant or a plant propagation material.

The present invention is also directed to a seed that is protected against multiple fungi comprising a seed treated with composition of cyazofamid. Advantageously the present compositions provide significant efficacy in the control of phytopathogenic fungi.

The present invention provides the use of cyazofamid for controlling phytopathogenic fungi by applying cyazofamid to a plant propagation material.

In an embodiment, the present invention provides the use of cyazofamid for controlling phytopathogenic fungi comprising applying cyazofamid to crop seeds in an amount ranging from 1 g/100 kg seeds to 500 g/100 kg seeds.

In a further embodiment, the present invention provides the use of cyazofamid formulated as a liquid composition and at least on agrochemically acceptable excipient for controlling phytopathogenic fungi.

In an embodiment, the present invention provides the use of a composition comprising cyazofamid, the composition is applied in an amount ranging from 10 ml/100 kg of seeds to 300 ml/100 kg of seeds.

In an embodiment, the present invention provides the use of a fungicidal combination comprising cyazofamid and a fungicide(s), the said combination is applied to a plant propagation material.

In an embodiment, the present invention provides the use of cyazofamid for treating seeds comprising applying cyazofamid to crop seeds in an amount ranging from 1 g/100 kg seeds to 500 g/100 kg seeds, to inhibit phytopathogenic fungi.

In view of the above, it will be seen that the several advantages of the invention have been achieved and other advantageous results have been attained.

Although the present invention has been disclosed in full, it will be understood that numerous additional modifications and variations could be made thereto without departing from the scope of the invention.

### EXAMPLES

### Example 1: Evaluation of Anti-Fungal Activity of Sunflower Seeds Treated with Cyazofamid Against Plasmopara halstedii

### (a) Seed Inoculation

One tray for each treatment was filled with perlite that was covered with two layers of watered paper. Treated seeds were placed between the layers under sterile conditions and incubated at 22° C. to 24° C., 100% relative humidity (RH) for 48 h. Zoosporangia from cotyledons of sunflower plants previously infected by an isolate of P. halstedii were removed with deionized water. The suspension was filtered through two layers of sterile cheesecloth and the inoculum concentration was adjusted to 2×10⁵ zoosporangia/ml. Treated and germinated seeds were immersed in the zoosporangial suspension for 5 hours. Bioassays were then designed and conducted under controlled growth conditions.

### (b) Seed Treatment

Five pots per treatment were filled with perlite and nine sunflower seeds were sown in each pot. Plants were grown at 19° C., 70-100% relative humidity and a 10 h dark/14 h light photoperiod for 12 days. The seed arrangement was made as 50 seeds/plot (pot10×10 cm). The treatments used are depicted below.

TABLE 1
Treatment protocol

| | | | Application |
|---|---|---|---|
| | | | rate |
| No. | Treatment | Concentration | g/100/kg |
| 1. | Untreated | — | — |
| | (Non-inoculated) | | |
| 2. | Untreated | — | — |
| | (Inoculated) | | |
| 3. | Cyazofamid | 160 g/l (Suspension | 10 |
| 4. | | concentrate) | 50 |
| 5. | | | 100 |
| 6. | Metalaxyl | 317 g/L | 35 |
| 7. | | 'Flow concentrate) | 60 |

### (c) Field Trial Results

The % incidence of fungal disease caused by Plasmapora halstedii was observed 12 DAS (days after sowing seeds).

TABLE 2
% Incidence

| | | Application rate | |
|---|---|---|---|
| No. | Treatment | g/100/kg | % Incidence |
| 1. | Untreated | — | 0 |
| | (Non-inoculated) | | |
| 2. | Untreated | — | 74.80 |
| | (Inoculated) | | |
| 3. | Cyazofamid | 50 | 0 |
| 4. | | 100 | 0 |
| 5. | Metalaxyl | 35 | 53.49 |
| 6. | | 60 | 62.24 |

The % incidence of fungal diseases is completely depleted in plants emerging from sunflower seeds. Comparatively, in seeds treated with metalaxyl, the occurrence of fungal disease is high.

### Example 2: Evaluation of Anti-Fungal Activity of Maize Seeds Treated with Cyazofamid Against Pythium ultimum

The present inventors have determined the % pathogen control of Pythium ultimum control in wheat grains treated with cyazofamid in field trials. The treatments employed and the results have been depicted in table 3 below.

TABLE 3

| | | Concentration | Application rate | P. ultimum |
|---|---|---|---|---|
| No. | Treatment | g.ai/100 kg | ml /100 kg seeds | patch score |
| 1. | Untreated control | — | — | 2.8 a |
| 2. | Cyazofamid | 10 | 25 ml | 1.5 b |
| 3. | Cyazofamid | 20 | 50 ml | 1.5 b |
| 4. | Cyazofamid | 30 | 75 ml | 1.5 b |
| 5. | Cyazofamid | 50 | 125 ml | 1.5 b |
| 6. | Cyazofamid | 100 | 250 ml | 1.3 b |

ab: statistical difference

The P. ultimum patch score indicating the severity of the fungal disease was observed to be significantly low and treated successfully using cyazofamid compared to the untreated control.

1. A method for inhibiting phytopathogenic fungi comprising applying cyazofamid to a plant propagation material.

2. The method as claimed in claim 1, wherein the plant propagation material comprises a seed, rhizome and tuber.

3. The method as claimed in claim 1, wherein the plant propagation material is a seed.

4. The method as claimed in claim 3, the method comprising applying cyazofamid to seed in an amount ranging from 1 g/100 kg seeds to 500 g/100 kg seeds.

5. The method as claimed in claim 3, the method comprising applying cyazofamid to seed in an amount ranging from 5 g/100 kg seeds to 250 g/100 kg seeds.

6. The method as claimed in claim 1, wherein cyazofamid is applied as a liquid composition.

7. The method as claimed in claim 6, wherein the liquid composition comprises a suspension concentrate (SC), an emulsifiable concentrate (EC), a flowable concentrate, a flowable suspension (FS), a microemulsion (ME), an oil dispersion (OD), or a suspoemulsion (SE).

8. The method as claimed in claim 6, wherein the liquid composition is a suspension concentrate (SC) or a flowable suspension (FS).

9. The method as claimed in claim 6, wherein the liquid composition comprises cyazofamid in a concentration ranging from 10% w/v to 60% w/v.

10. The method as claimed in claim 6, wherein the liquid composition further comprises an agrochemically acceptable excipient in an amount ranging from 0.1% to 30% w/w of total weight of the composition.

11. The method as claimed in claim 10, wherein the agrochemically acceptable excipient is selected from the group consisting of surfactants, antifreeze agent, wetting agent, antifoaming agent, thickening agent, preservative, colorant, filler, and combinations thereof.

12. The method as claimed in claim 6, wherein the composition comprising cyazofamid is applied in an amount of 10 ml/100 kg of seeds to 300 ml/100 kg of seeds.

13. The method as claimed in claim 1, wherein the phytopathogenic fungi comprises Plasmopara sp., Phytophthora sp., or Pythium sp.

14. The method as claimed in claim 1, wherein the phytopathogenic fungi comprises Plasmopara halstedii, Phytophthora sojae, or Pythium ultimum.

15. A method of treating a seed for controlling phytopathogenic fungi comprising applying cyazofamid to seed in an amount ranging from 1 g/100 kg seeds to 500 g/100 kg seeds.

16. The method as claimed in claim 15, the method comprising applying cyazofamid to seeds in an amount ranging from 5 g/100 kg seeds to 250 g/100 kg seeds.

17. The method as claimed in claim 15, wherein the seed comprises a fruit seed, a vegetable seed, cereal, row crop, oil seeds, legumes.

18. The method as claimed in claim 15, wherein the seed is corn, wheat, rice, sunflower, or canola seed.

19. The method as claimed in claim 15, wherein cyazofamid is formulated as a liquid seed treatment composition comprising suspension concentrate (SC) or a flowable suspension (FS).

20. The method as claimed in claim 1, the method comprising applying a fungicidal combination comprising cyazofamid and fungicide(s) to the plant propagation material.

21. The method as claimed in claim 20, wherein the fungicide(s) is a systemic or contact fungicide.

22. The method as claimed in claim 21, the systemic fungicides is selected from the group comprising nucleic acid synthesis inhibitor, cytoskeleton and motor protein inhibitors, amino acids and protein synthesis inhibitors, respiration process inhibitors, signal transduction inhibitors, lipid synthesis and membrane integrity disruptors, sterol biosynthesis inhibitors, melanin synthesis inhibitors, cell wall biosynthesis inhibitors, melanin synthesis inhibitor in cell wall, host plant defence inducers, fungicides with unknown modes of action, fungicide with no classification, or biologicals with multiple mode of action.

23. The method as claimed in claim 21, the contact fungicides may be selected from the group comprising dithiocarbamates, phthalimides, sulfamides, bisguanidine, triazines, quinone, quinoxaline, maleimide, and thiocarbamates.

24. (canceled)

25. (canceled)

26. (canceled)

27. (canceled)

28. (canceled)

29. The method of claim 1, further comprising: contacting the cyazofmid with perlite positioned between two layers of watered paper; and placing the plant propagation material between the two layers of watered paper.
